(19) United States
(12) Patent Application Publication
(10) Pub. No.: US 2007/0253796 A1
(43) Pub. Date: Nov. 1, 2007

(54) CLIP ATTACHABLE TO AND DETACHABLE FROM A WORKPIECE

(76) Inventor: Yasuhiro Kawai, Toyohashi-shi (JP)

Correspondence Address: MILES & STOCKBRIDGE PC, 1751 PINNACLE DRIVE, SUITE 500, MCLEAN, VA, 22102-3833, US

(21) Appl. No.: 11/694,133

(22) Filed: Mar. 30, 2007

(30) Foreign Application Priority Data
Mar. 30, 2006 (JP) 2006-092918

(51) Int. Cl. F16B 19/00

(52) U.S. Cl. 411/508

(57) ABSTRACT

A plastic clip has a shank extending from a flange at one end of the shank and a pair of divergent resilient arms extending toward the flange from the opposite end of the shank. When the shank and the arms are inserted in a hole in a workpiece, portions of the arms engage edge regions of the hole to attach the clip to the workpiece. Each arm is hingedly connected to a disengagement actuator resiliently connected to the flange and moveable by a tool inserted in an opening in a peripheral portion of the flange to disengage the arm from the workpiece, so that the clip can be detached from the workpiece.

### CROSS-REFERENCE TO RELATED APPLICATION

This invention claims the benefit of Japanese Application No. 2006-092918 filed Mar. 30, 2006 and incorporated herein by reference.

### BACKGROUND OF THE INVENTION

This invention relates to a clip comprising a flange, a shank extending from the flange at one end of the shank, and a pair of resilient arms extending divergently from the opposite end of the shank toward the flange. The arms have engaging portions that engage an edge of a mounting hole of a workpiece when the shank and the arms are inserted in the hole to attach the clip to the workpiece. In particular, the invention relates to a construction of the clip that facilitates detachment of the clip from the workpiece.

Japanese Utility Model Laid-Open Publication No. 55-36735 (Patent Publication 1) and Japanese Patent Laid-Open Publication No. 2003-168878 (Patent Publication 2) disclose clips of the foregoing type, but without features of the invention that facilitate detachment of the clip from a workpiece. Although Patent Publication 2 discloses a clip capable of facilitating detachment of the clip from a workpiece manually, the configuration of the clip is undesirably complicated, which increases production costs.

### BRIEF DESCRIPTION OF THE INVENTION

The present invention provides a clip that is easily detached from a workpiece without the need for a complicated configuration.

In an embodiment of the invention, engagement portions of resilient arms that engage edge regions of a workpiece mounting hole, to attach the clip to the workpiece, are disengaged by actuators hingedly connected to the arms and moved by tools inserted laterally in a space beneath a main portion of the flange. The flange may be provided with a holder for a device to be mounted on the workpiece.

### BRIEF DESCRIPTION OF THE DRAWINGS

The invention will be further described in conjunction with the accompanying drawings, which illustrate preferred (best mode) embodiments, and wherein:

FIG. 1 is a front view of a clip according to a first embodiment of the invention;

FIG. 2 is a right side view of the clip in FIG. 1;

FIG. 3 is a sectional view of the clip, taken along line A-A in FIG. 1;

FIG. 4 is a right side view of the clip in FIG. 1, after the clip is attached to a workpiece;

FIG. 5 is a right side view of the clip in FIG. 1, during a detachment operation;

FIG. 6 is an explanatory view showing loci of parts during a detachment operation;

FIG. 7 is a perspective view of a clip according to a second embodiment of the invention, the clip being viewed from a front side thereof;

FIG. 8 is a perspective view of the clip in FIG. 7, the clip being viewed from a rear side thereof;

FIG. 9 is a perspective view of a rear portion of the clip in FIG. 8, as viewed from a different direction;

### DETAILED DESCRIPTION OF THE INVENTION

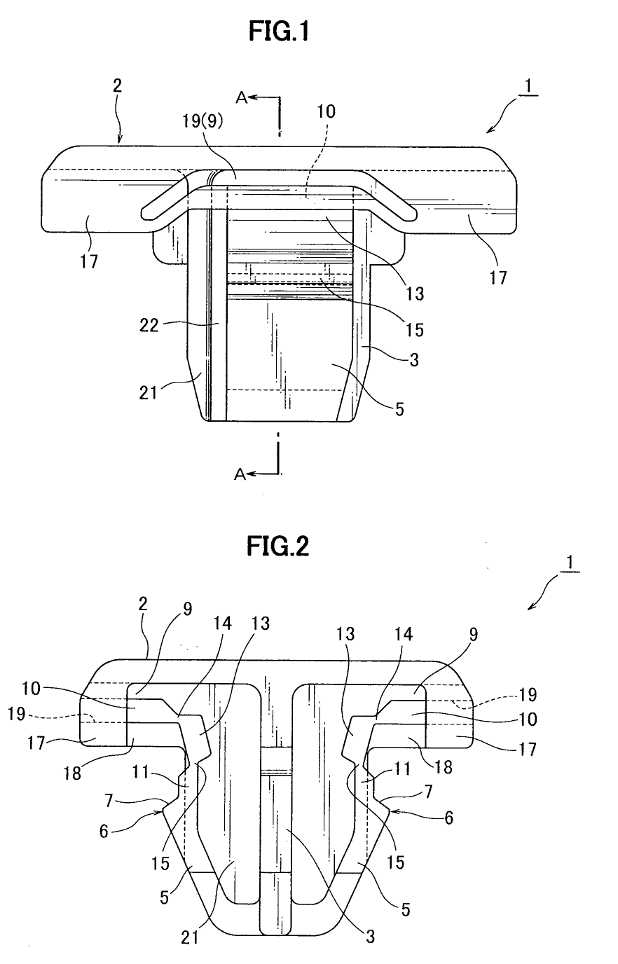

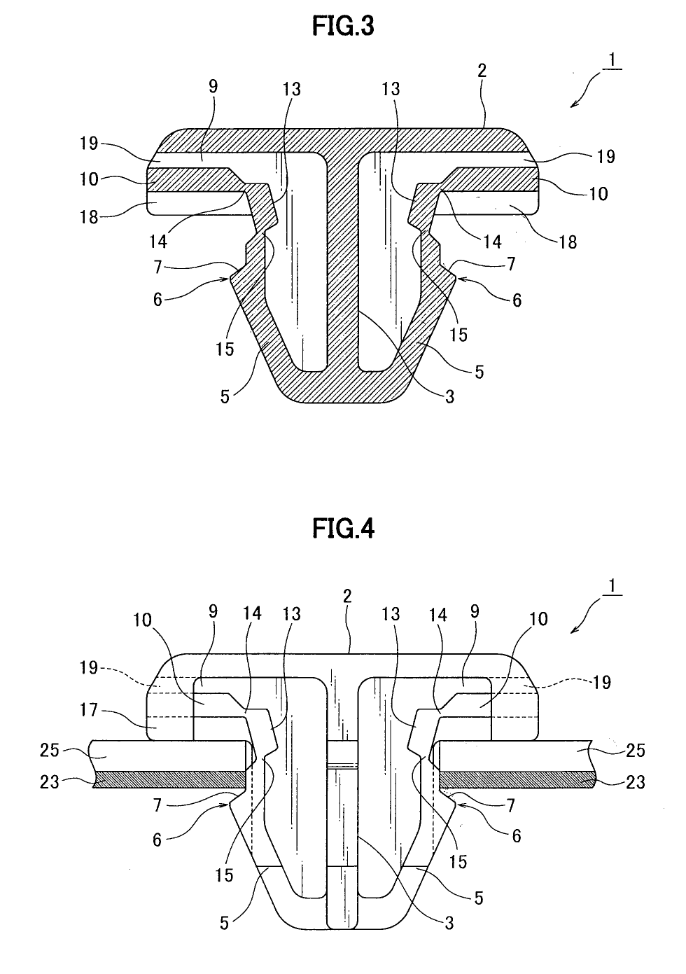

A clip according to an embodiment of the present invention will now be described with reference to FIGS. 1-6.

The clip 1 is preferably formed of plastic in one piece by an integral molding process using hard synthetic resin material. The clip comprises a flange 2, a shank 3 extending perpendicularly from a main portion of the flange at one end of the shank, and a pair of resilient arms 5 diverging from an opposite end of the shank toward the flange 2. The flange is formed in a plate-shape having a size capable of being stably seated on a workpiece. While the shape of the flange viewed in a direction perpendicular to its main portion may be circular or rectangular, for example, in the illustrative embodiment the flange shape is somewhat oval, formed as by rounding four corners of a rectangle. As shown in FIGS. 1 and 2, each of the shank 3 and the arms 5 is plate-shaped, having a relatively thick wall and a uniform width to provide stable high attachment strength when the clip is attached to a workpiece in a manner to be described.

Each of the arms 5 has an engaging portion 6 adjacent to the flange 2 and formed to be engageable with an edge of a mounting hole in a workpiece. The engaging portion 6 has a shoulder 7 for engaging an edge region of the mounting hole, whereby the clip is attached to the workpiece.

The clip 1 has a pair of resiliently supported detachment actuators 10 associated with the respective arms 5 and disposed under the flange 2 (on the shank side of the flange), so as to define a space 9 between each detachment actuator and the underside of the flange, and a space 18 beneath each actuator. Each of the actuators 10 is plate-shaped, extends from an outer periphery of the flange 2, and is connected to an engaging portion 6 via a hinged section.

The hinged section includes a pair of hinges 14 and 15 with a rigid intermediate piece 13 between the hinges. Each resilient arm 5, its hinged section, and its disengagement actuator are formed as a single plate-shaped segment having a substantially uniform width. Each hinge is defined by a pair of diverging surfaces and a thin-walled portion of the segment at the vertex of the surfaces. The divergent surfaces of hinges 14 face in the general direction of the flange 2 at one side of the segments, while the divergent surfaces of hinges 15 face away from the shank 3 at the opposite side of the segments.

The flange 2 has an outer peripheral wall 17 which extends substantially perpendicularly from the main portion of the flange. Wall 17 provides space beneath the main portion of the flange, between the main portion of the flange and the workpiece, in which the detachment actuators 10, the hinges 14, and the intermediate pieces 13 can move in order to detach the clip from a workpiece in a manner to be described.

Clip 1 has a reinforcing plate 21 extending along the shank 3 beneath the flange 2 substantially perpendicular thereto. The reinforcing plate 21 has a length substantially equal to that of the shank 3. In the embodiment, a reinforcing plate is formed at only one side of the shank 3 and the arms 5 and is integrally connected to the shank 3 through a connection portion 22 (FIG. 1). The reinforcing plate not only enhances the attachment strength of the clip 1; it can also serve as a guide for determining the appropriate orientation of the clip for insertion of the shank 3 and the arms 5 in a mounting hole in a workpiece.

FIG. 4 shows the clip attached to workpieces 23 and 25. Workpiece 23 may be a panel, for example, and workpiece 25 a lining on the panel. During an operation of attaching the clip to the workpieces, each of the engaging portions 6 of the arms 5 is flexed toward the center of a mounting hole as the arms are inserted in the hole. As the shoulders 7 pass through the mounting hole, the arms 5 spring back to their original positions, and the shoulders 7 are locked under the workpiece 23 to attach the clip to the workpieces. At this time, the peripheral portion 17 of the flange engages workpiece 25, as shown in FIG. 4, and clamps workpiece 25 to workpiece 23.

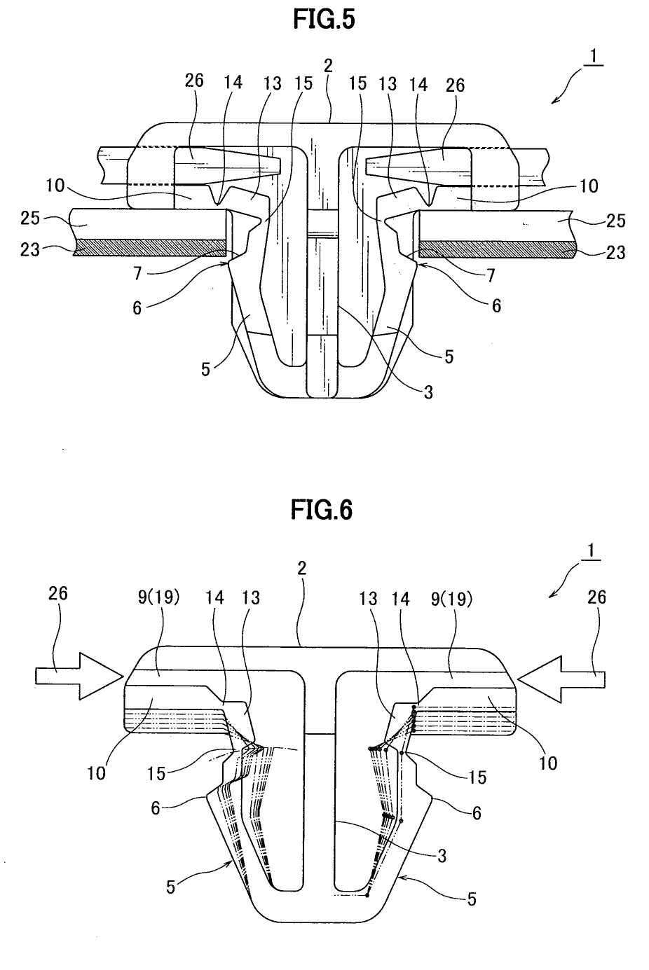

FIGS. 5 and 6 show the manner in which the clip can be detached from the workpieces when desired. As shown in FIG. 5, insertion members 26, such as flat blade screwdrivers, are inserted laterally into openings 19 (see FIG. 4) in the wall 17 of the flange 2 and into the spaces 9 between the detachment actuators 10 and the flange 2. In response to this insertion, actuators 10 are bent away from the main portion of the flange 2 into spaces 18 beneath the actuators, causing the diverging surfaces of each hinge to move toward one another as the rigid intermediate pieces 13 turn, which releases the shoulders 7 of the arms 5 from the workpiece 23. In this operation, the engaging portions 6 move inwardly toward the shank 3 as the divergence of the arms 5 decreases. Compare FIGS. 4 and 5. FIG. 6 shows diagrammatically the loci of the various parts of each arm segment during a detachment operation. After the engaging portions 6 are released from engagement with the edge of the mounting hole of the workpieces 23, 25, the insertion members 26 can be moved to lift the clip 1 away from the workpieces.

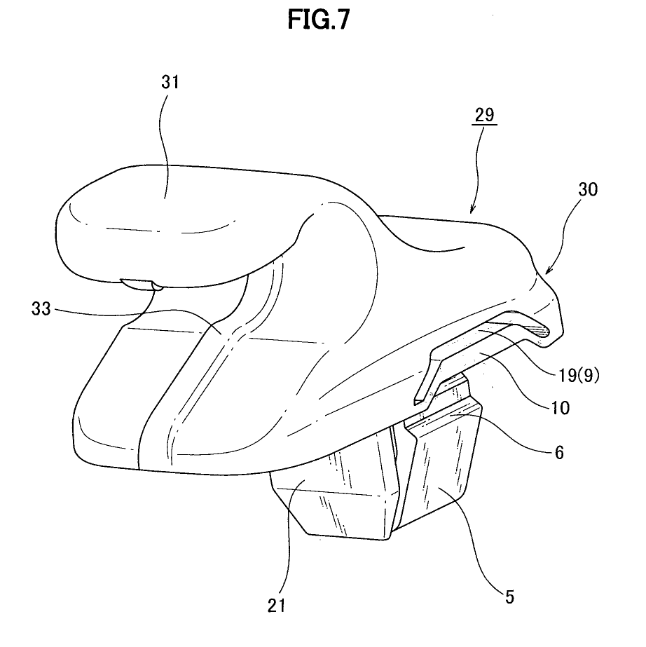

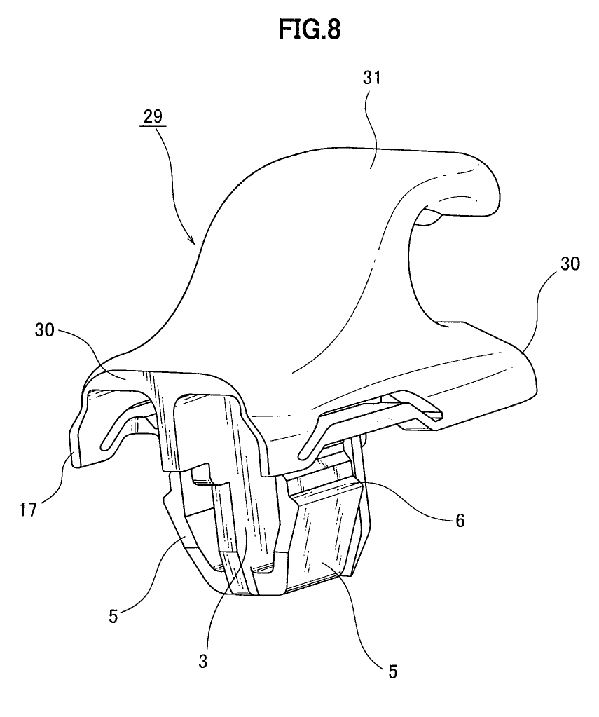

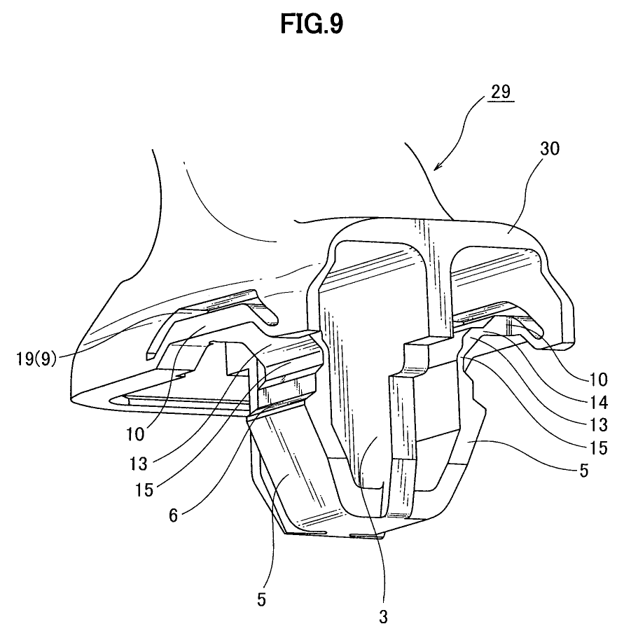

FIGS. 7-9 show a clip 29 according to a second embodiment of the invention. The clip 29 is, again, preferably formed as a single piece of hard plastic by an integral molding process. The basic structure of the clip 29 is substantially the same as that of the clip 1. Clip 29 differs from the clip 1 in that a flange 30 of the clip 29 is configured as a holder for attaching a device to a workpiece. The perspective views in FIGS. 7-9 are helpful in augmenting the previous description of the basic clip elements. For example, the plate shapes of certain elements are clearly shown in these figures, as is the resilient mounting of the detachment actuators 10 by virtue of thin-walled portions of the wall 17.

As shown in FIGS. 7-9, the configuration of the flange 30 at the side opposite to the shank 3 and the resilient arms 5 forms a resilient clamp 31 which can receive a sun-visor mounting shaft, for example. The clamp 31 has an inner surface formed with a smooth protrusion 33 to allow the received shaft to be readily inserted in the clamp and pulled out therefrom.

From the foregoing description of the invention, it will be apparent that the invention provides a simple clip that is easy to manufacture and use. By virtue of its simple configuration, production costs are reduced. A clip of the invention can be used to plug an unused hole in a workpiece and can be used to attach a device, such as a sun visor, to a workpiece. Furthermore, attachment of the clip of the invention to a workpiece is secure, because, in a preferred embodiment, detachment of the clip from the workpiece requires insertion of tools into openings in a sidewall of the flange.

While preferred embodiments of the invention have been shown and described, it will be apparent from the foregoing description that changes can be made without departing from the principles and spirit of the invention, the scope of which is defined in the claims which follow.

What is claimed is:

1. A clip comprises a flange, a shank extending from the flange at one end of the shank, and a pair of resilient divergent arms extending from an opposite end of the shank toward the flange, each arm having an engaging portion adjacent to the flange to engage an edge of a mounting hole of a workpiece into which the shank and the arms are inserted, with the flange adjacent to the workpiece, wherein the clip further comprises:
a pair of disengagement actuators hingedly connected to the respective arms and extending beneath a main portion of the flange spaced therefrom so that tools can be inserted between the main portion of the flange and the disengagement actuators to move the actuators away from the main portion of the flange to cause the engagement portions of the arms to disengage from the edge of the mounting hole.

2. A clip as defined in claim 1, wherein the connection between each disengagement actuator and the respective resilient arm includes a pair of spaced hinges with a rigid member between the hinges.

3. A clip as defined in claim 2, wherein each of the hinges is defined by a pair of diverging surfaces moveable toward one another in response to movement of a respective disengagement actuator away from the main portion of the flange, one of the pair of divergent surfaces facing the main portion of the flange and the other pair of divergent surfaces facing outwardly of the shank.

4. A clip as defined in claim 1, wherein the flange has an outer peripheral portion extending from the main portion of the flange to define spaces for movement of the disengagement actuators away from the main portion of the flange.

5. A clip as defined in claim 4, wherein the peripheral portion of the flange has openings for receiving tools to move the respective disengagement actuators.

6. A clip as defined in claim 5, wherein each disengagement actuator is a plate resiliently connected to the peripheral portion of the flange at opposite edges of the plate.

7. A clip as defined in claim 1, wherein the clip further comprises a reinforcing plate extending along the shank from the main portion of the flange to the opposite end of the shank.

8. A clip as defined in claim 1, wherein the clip is a single piece of plastic.

9. A clip as defined in claim 2, wherein, for each arm, all of the disengagement actuator, the hinges, the rigid member and the arm constitute a single plate-shaped segment of substantially uniform width, and wherein the hinges include thin-walled portions of the segment.

10. A clip as defined in claim 1, wherein the main portion of the flange is constructed to provide a holder for holding a device at a side of the main portion opposite to the side from which the shank extends.

11. A clip as defined in claim 10, wherein the holder is a clamp for holding a mounting shaft of a sun visor.

12. A clip comprising a flange, a shank extending substantially perpendicularly from a main portion of the flange at one end of the shank, and a resilient arm extending from an opposite end of the shank toward the flange and having an engagement portion for engaging an edge region of a mounting hole, wherein the flange has a peripheral wall extending from the main portion of the flange in substantially the same direction as the shank, the arm has a disengagement actuator extending in a space beneath the main portion of the flange to the peripheral portion of the flange, the peripheral portion of the flange has an opening for receiving a tool to move the actuator, and the actuator is connected to the engagement portion of the arm in a manner such that movement of the actuator by the tool inserted in the opening moves the engagement portion in a disengaging direction.

13. A clip according to claim 12, wherein the actuator is connected to the engagement portion by a hinged section of the arm and is moved by the tool in a direction away form the main portion of the flange to cause the engagement portion to move in the disengagement direction.

14. A clip according to claim 13, wherein the hinged section has a rigid portion between a pair of hinges, one of the hinges connecting the rigid section to the actuator and the other hinge connecting the rigid section to the engagement portion.

15. A clip according to claim 14, wherein the one hinge has a pair of surfaces diverging toward the main portion of the flange at one side of the arm and the other hinge has a pair of surfaces diverging in a direction away from the shank at an opposite side of the arm.

16. A clip according to claim 15, wherein the construction of the arm is such that the divergence of the surfaces of the hinges increases as the actuator moves away from the main portion of the flange.
